(19) United States
(12) Patent Application Publication
(10) Pub. No.: US 2020/0090509 A1
(43) Pub. Date: Mar. 19, 2020

(54) VEHICLE MONITORING METHOD AND APPARATUS

(71) Applicant: BOE TECHNOLOGY GROUP CO., LTD., Beijing (CN)

(72) Inventor: Wenchu DONG, Beijing (CN)

(73) Assignee: BOE TECHNOLOGY GROUP CO., LTD., Beijing (CN)

(21) Appl. No.: 16/618,548

(22) PCT Filed: May 10, 2018
(86) PCT No.: PCT/CN2018/086281

§ 371 Date: Dec. 2, 2019

(30) Foreign Application Priority Data
Jun. 19, 2017 (CN) 201710464676.X

(51) Int. Cl. G08G 1/0962; G08G 1/16; G06K 9/00; G06T 11/00; B60K 35/00

(52) U.S. Cl. CPC G08G 1/0962; B60K 2370/21; G08G 1/166; G06K 9/00805; G06K 9/00671; G06T 11/001; B60K 35/00; G06K 2209/15; G06K 2209/23; B60K 2370/167; B60K 2370/179; B60K 2370/193; B60K 2370/52; B60K 2370/592; G08G 1/163

(57) ABSTRACT

A vehicle monitoring method and apparatus are provided. The method includes: acquiring first information of one or more second vehicles within a preset distance from a first vehicle; determining, based on the first information, respective display modes for the one or more second vehicles; and displaying, according to the determined respective display modes, the second vehicles on a display device of the first vehicle. The solution provided in the embodiments of the present disclosure enables an effective alert and display of the status of surrounding vehicles.

### CROSS-REFERENCE TO RELATED APPLICATIONS

This application is the U.S. national phase of PCT Application No. PCT/CN2018/086281 filed on May 10, 2018, which claims priority to Chinese Patent Application No. 201710464676.X filed on Jun. 19, 2017, which are incorporated herein by reference in their entireties.

### TECHNICAL FIELD

Embodiments of the present disclosure relate to the field of vehicle-mounted equipment, in particular to a vehicle monitoring method and related apparatus.

### BACKGROUND

With an increasing quantity of vehicles on the roads year by year, frequent occurrences of traffic accidents and the need for intelligent driving and danger avoidance have become a concern.

Conventional intelligent driving systems mainly focus on aspects such as vehicle automatic driving, enhancement of driving experiences, automatic detection of a distance relative to a front vehicle or a rear vehicle, and automatic detection of switching of traffic lights to improve safety. However, these systems have little consideration for risks of traffic accidents posed by human factors, and thus cannot fully guarantee driving safety.

### SUMMARY

According to an aspect of embodiments of the present disclosure, a vehicle monitoring method is provided. The method includes: acquiring first information of one or more second vehicles within a preset distance from a first vehicle; determining, based on the first information, respective display modes for the one or more second vehicles; and displaying, according to the determined respective display modes, the one or more second vehicles on a display device of the first vehicle.

In some embodiments, the first information includes at least one of vehicle speed information, vehicle age information and vehicle violation record information. The acquiring the first information of one or more second vehicles within the preset distance from the first vehicle includes: detecting the vehicle speed information of the one or more second vehicles by using a speed detector in the first vehicle and/or requesting information of the one or more second vehicles from a data management server, and generating the first information based on the detected vehicle speed information of the one or more second vehicles and/or information of the one or more second vehicles returned by the data management server.

In some embodiments, the method further includes: acquiring second information of one or more drivers of the one or more second vehicles. The determining the respective display modes for the one or more second vehicles includes: determining, based on the first information and the second information, the respective display modes for the one or more second vehicles.

In some embodiments, the acquiring the first information and the second information of the one or more second vehicles further includes: sending a data request for the first information and/or the second information to a data management server; receiving information returned by the data management server in response to the data request; and parsing the returned information to acquire the first information and/or the second information of the one or more second vehicles.

In some embodiments, the data request includes identification information of the first vehicle or the one or more second vehicles.

In some embodiments, the determining the respective display modes for the one or more second vehicles includes: determining whether there is a risk-posing vehicle in the one or more second vehicles based on the acquired first information and/or second information of the one or more second vehicles; and determining to display the risk-posing vehicle in a display mode different from that of other vehicles in case that it is determined there is the risk-posing vehicle in the one or more second vehicles.

In some embodiments, the displaying the risk-posing vehicle in the display mode different from that of other vehicles includes: displaying the risk-posing vehicle in a different color or in a flickering manner.

In some embodiments, the determining whether there is a risk-posing vehicle in the one or more second vehicles is further based on different rules. The method further includes: displaying risk-posing vehicles, determined based on the different rules, in different display modes.

According to another aspect of the embodiments of the present disclosure, a vehicle monitoring apparatus is provided. The apparatus includes a processor and a display. The processor is configured to acquire first information of one or more second vehicles within a preset distance from a first vehicle, and determine respective display modes for the one or more second vehicles based on the first information. The display is configured to display the one or more second vehicles according to the respective display modes determined by the processor.

In some embodiments, the apparatus further includes a speed detector configured to detect vehicle speed information of the one or more second vehicles. The processor is configured to acquire the vehicle speed information of the one or more second vehicles from the speed detector as the first information.

In some embodiments, the processor is further configured to acquire second information of one or more drivers of the one or more second vehicles, and determine the respective display modes for the one or more second vehicles based on the first information and the second information.

In some embodiments, the apparatus further includes a communication interface configured to communicate with a data management server. The processor is configured to send a data request for the first information and/or the second information of the one or more second vehicles to the data management server via the communication interface, and generate the first information and/or the second information based on information returned by the data management server. Optionally, the processor is configured to incorporate identification information of the first vehicle and/or the one or more second vehicles in the data request.

In some embodiments, the apparatus further includes an image identification device configured to identify license plate information or driver information of the one or more second vehicles as identification information of the one or more second vehicles by capturing an image of the one or more second vehicles and analyzing the captured image of the one or more second vehicles.

In some embodiments, the processor is configured to determine whether there is a risk-posing vehicle in the one or more second vehicles based on at least one of the acquired first information and second information of the one or more second vehicles, and display the risk-posing vehicle in a display mode different from that of other vehicles in case that it is determined there is the risk-posing vehicle in the one or more second vehicles.

### BRIEF DESCRIPTION OF THE DRAWINGS

In order to achieve the foregoing and related objectives, the following description and drawings illustrate some illustrative aspects and implementations. These are just a few of various ways in which one or more aspects may be used. Other aspects, advantages and novel features of the present disclosure will become apparent from the following detailed description when considered with reference to the drawings.

FIG. 1 is a flow chart of an exemplary vehicle monitoring method according to the embodiments of the present disclosure;

FIG. 2 is a flow chart of an exemplary process for obtaining first information of a vehicle according to the embodiments of the present disclosure;

FIG. 3 is a flow chart of an exemplary process for generating returned information according to the embodiments of the present disclosure;

FIG. 4 is a flow chart of an exemplary method for displaying and identifying a vehicle according to the embodiments of the present disclosure;

FIG. 5 is an example of a graphic interface displaying travelling status of various vehicles according to the embodiments of the present disclosure; and

FIG. 6 is a schematic structural diagram of an exemplary vehicle monitoring apparatus according to the embodiments of the present disclosure.

### DETAILED DESCRIPTION

Hereinafter, specific embodiments of the present disclosure will be described with reference to the drawings; however, it should be appreciated that the disclosed embodiments are only examples of the present disclosure, which may be implemented in various ways. Well known and/or repeated functions and structures are not described in detail to avoid unnecessary or redundant details that may obscure the present disclosure. Therefore, the specific structural and functional details disclosed herein are not intended to limit the present disclosure, but are only used as a basis of claims and representative basis to teach those skilled in the art to use the present disclosure in a variety of ways and in substantially any suitable detailed structure.

A phrase “in one embodiment”, “in another embodiment”, “in still another embodiment” or “in other embodiments” may be used in the description, which may refer to one or more of the same or different embodiments according to the present disclosure.

The embodiments of the present disclosure are described in detail below with reference to the accompanying drawings. The embodiments of the present disclosure provide a vehicle monitoring method, which may display identifiers of various vehicles correspondingly based on the acquired information of surrounding vehicles. Therefore, it is convenient to alert a driver to the status of surrounding vehicles; especially when there is a danger, the driver may also be assisted to perform corresponding operation quickly, thereby reducing a risk of driving and providing a safer driving environment.

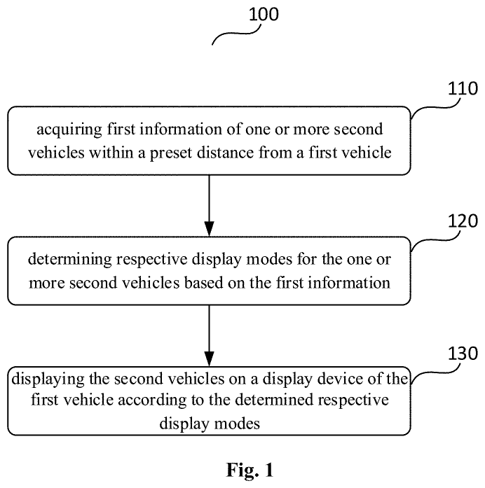

FIG. 1 is a flow chart of an exemplary vehicle monitoring method 100 according to the embodiments of the present disclosure. The method includes the following blocks.

Block 110: acquiring first information of one or more second vehicles within a preset distance from a first vehicle.

Block 120: determining respective display modes for the one or more second vehicles based on the first information.

Block 130: displaying the second vehicles on a display device of the first vehicle according to the determined respective display modes.

In the embodiments of the present disclosure, the first information about the second vehicles may be vehicle-related information involving driving safety. For example, the first information may include at least one of: positioning information, driving lane information, running speed information, vehicle violation record information and vehicle age information of the second vehicles.

In the embodiments of the present disclosure, the first information of the second vehicles (hereinafter also referred to as surrounding vehicles) may be detected by using a detection device provided in the first vehicle (hereinafter also referred to as a target vehicle). Additionally or alternatively, the first information of the second vehicles may also be requested from a remote data management server.

In the embodiments of the present disclosure, speed information of the surrounding vehicles within the preset distance from the first vehicle may be detected by a speed detector mounted on the first vehicle, and the first information may be generated based on the speed information. The preset distance may be set autonomously according to detection accuracies or configuration requirements of various instruments in the detection device of the vehicle. In some embodiments, speed differences (relative speeds) between the first vehicle and the surrounding second vehicles may be detected by the speed detector provided in the first vehicle, and a running speed of each surrounding vehicle may be acquired according to the acquired relative speed and the speed information of the first vehicle.

After acquiring the running speed, it is also possible to determine whether the running speed exceeds a speed limit based on the speed limit of current road segment. If the running speed exceeds the speed limit, the vehicle corresponding to the running speed is displayed in a different display mode.

In some embodiments, the second information of the corresponding drivers of the second vehicles may be acquired additionally. The second information may be driver-related information involving driving safety. For example, the second information may include at least one of following information: driver age, gender, driving experience, health condition, driver violation record and the like. The display modes in which the second vehicles are displayed may also be additionally determined based on the second information. In some embodiments, the second information may also be displayed in association with the respective vehicles.

The method according to the embodiments of the present disclosure may be implemented in combination with any suitable hardware, software, firmware, or combination thereof. In at least some embodiments, the method may be performed by software in form of computer readable instructions stored on certain type of computer readable storage medium, where the software may be executed on one or more processors.

According to the embodiments of the present disclosure, by detecting the first information of the surrounding vehicles within the preset distance from the target vehicle and optionally detecting the second information, various surrounding vehicles are identified and displayed by a display in different display modes or display states.

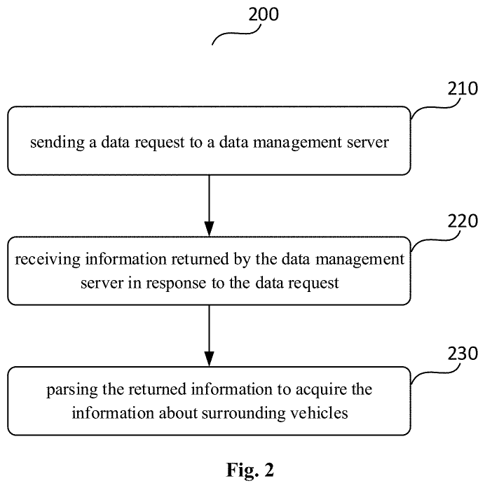

FIG. 2 is a flow chart of an exemplary process 200 for acquiring the information by means of the data management server according to the embodiments of the present disclosure. The process for acquiring the information may include the following blocks.

Block 210: sending a data request to a data management server.

Block 220: receiving information returned by the data management server in response to the data request.

Block 230: parsing the returned information to acquire the information about surrounding vehicles.

The information may be the first information or the second information. That is, the vehicle monitoring apparatus may request the information of the surrounding vehicles and/or the information of corresponding drivers from the data management server. The data management server may include a server configured by a user, or may include an accessible server of the public security traffic supervision system. In some embodiments, the data in the public security traffic supervision system may also be accessed with the data management server acting as a proxy server. The data may include running speed information, positioning information, vehicle violation status information, and driver-related information for all vehicles within the jurisdiction of the traffic supervision system.

At the beginning of the process, the vehicle monitoring apparatus is activated. At this time, the vehicle monitoring apparatus may actively request the first information about the surrounding vehicles from the data management server, and thus generate the data request for the first information. In some embodiments, the data request may include identification information of the target vehicle or identification information of the surrounding vehicles. The identification information may include vehicle positioning information or vehicle license plate information. In some embodiments, the positioning information of the target vehicle may be obtained by, for example, a GPS locater. In some embodiments, the license plate information of the target vehicle may be pre-stored in a storage of the vehicle monitoring apparatus.

In some embodiments, images of the license plates of the surrounding vehicles may also be captured and analyzed to identify license plate numbers as the identification information of the surrounding vehicles. The license plate information of the target vehicle may also be read from the storage as the identification information of the target vehicle.

The data management server may acquire the identification information of the target vehicle or the surrounding vehicles from the received data request, and based on the identification information, search information of the surrounding vehicles associated with the target vehicle, such as the positioning information, running speeds, vehicle ages or violation records.

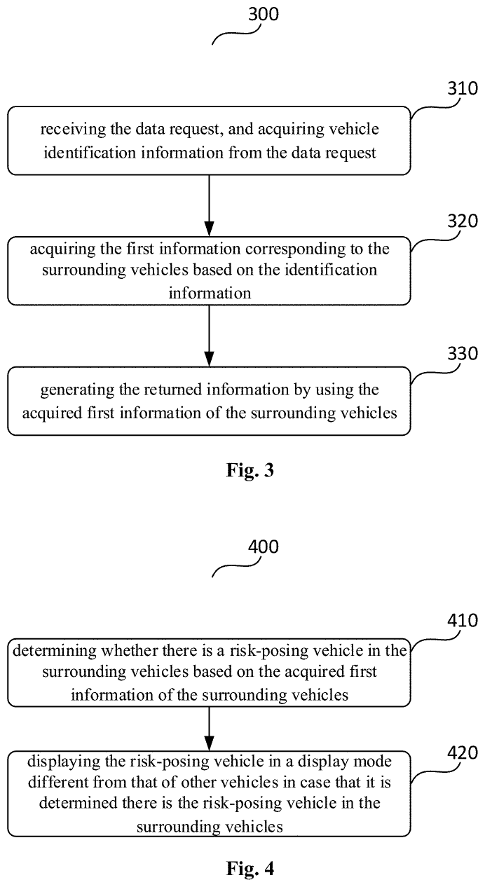

FIG. 3 is a schematic diagram of an exemplary process 300 of generating the returned information by the data management server according to the embodiments of the present disclosure. The process may include the following blocks.

Block 310: receiving the data request, and acquiring vehicle identification information from the data request.

Block 320: acquiring the first information corresponding to the surrounding vehicles based on the identification information.

Block 330: generating the returned information by using the acquired first information of the surrounding vehicles.

In some embodiments, having received the data request, the data management server may acquire the vehicle identification information from the data request. The identification information may be the identification information of the target vehicle or may include the identification information of the surrounding vehicles. The data management server may use the identification information as an index to retrieve the first information of the surrounding vehicles.

In one example, when the identification information is the positioning information of the target vehicle, the data management server may acquire a position of the target vehicle from the data request, and determine, based on the position of the target vehicle, the surrounding vehicles at the same or almost the same location (i.e., within a preset distance) as the target vehicle, for example, front and rear vehicles in the same lane, and vehicles running abreast, running ahead or running behind in adjacent lanes. Then the data management server may search the information of the determined surrounding vehicles, such as the speed information, vehicle violation information, etc., and generate the returned information and send it to the vehicle monitoring apparatus.

In another example, when the identification information is the license plate information of the surrounding vehicles, the data management server may acquire the license plate numbers of the surrounding vehicles from the data request. And the data management server may search current positioning information, the violation record information, or the speed information of the corresponding vehicles based on the license plate numbers, and generate the returned information based on the searched information and send it to the vehicle monitoring apparatus.

It should be appreciated that, the data management server may store the vehicle speed information and the positioning information uploaded in real time by the vehicle monitoring apparatus on the vehicle or basic vehicle information (license plate number, vehicle age) or violation information, so as to facilitate the analysis of the information of vehicles surrounding the target vehicle. Additionally or alternatively, the data management server may also search the information about the target vehicle or the surrounding vehicles in a database of the traffic supervision system and return the information to the corresponding vehicle monitoring apparatus.

In the embodiments of the present disclosure, each vehicle may upload the acquired vehicle speed information and positioning information to the data management server in real time, so as to facilitate the data management server to collect the first information of each vehicle. In addition, the data management server may also share the first information of vehicles within the jurisdiction of traffic supervision system with the public security traffic supervision system by communicating with the public security traffic supervision system.

After receiving the returned information from the data management server, the vehicle monitoring apparatus may acquire the first information of the surrounding vehicles from the returned information. Then the display modes of the surrounding vehicles may be adjusted adaptively according to the first information.

In some embodiments, the acquiring the second information of the drivers of the surrounding vehicles within a preset distance may include: capturing, by an image capture device, pictures of the drivers of the surrounding vehicles, and requesting, by using the pictures, the second information of the drivers corresponding to the surrounding vehicles from the data management server.

The image capture device may include a camera which may capture headshot information of the drivers of the surrounding vehicles. In some embodiments, the headshot information may also be analyzed by using a face identifying unit connected to the camera, to acquire basic information of a driver such as age, gender and the like.

Additionally or alternatively, the second information about the drivers of the surrounding vehicles may further be requested from the data management server. For example, the data request for the second information about the drivers may be generated and sent to the data management server. The data request may include captured pictures of the drivers, and may also be generated based on the identification information of the surrounding vehicles. After receiving the information returned by the data management server in response to the data request, the returned information may be parsed to acquire the second information of the drivers of the surrounding vehicles.

In the data management server, the information of the vehicles and the drivers may be stored correspondingly. The vehicle information may include the aforementioned first information of vehicle. The information of the drivers may include at least one of: age, driving experience, health information and violation records. The data in the data management server may be updated in real time. A mode of update may include: requesting the update data from the public security traffic supervision system regularly. Optionally, health data (diagnosis and treatment information, medical history, etc.) of each driver may also be requested from a health care management system. This ensures that the information of the vehicles and the drivers stored by the data management server are up to date and accurate.

As described above, real-time acquisition of the vehicle information and the driver information, and timely display may be achieved.

FIG. 4 is a flow chart of an exemplary method 400 for displaying and identifying the vehicles according to the embodiments of the present disclosure. In the method, displaying and identifying the corresponding vehicles on the display in the determined modes includes the following blocks.

Block 410: determining whether there is a risk-posing vehicle in the surrounding vehicles based on the acquired first information of the surrounding vehicles.

Block 420: displaying the risk-posing vehicle in a display mode different from that of other vehicles in case that it is determined there is the risk-posing vehicle in the surrounding vehicles. In some embodiments, the driver information of the risk-posing vehicle may additionally be displayed simultaneously.

In the embodiments of the present disclosure, information such as the positions and speeds of the surrounding vehicles relative to the target vehicle may be determined based on the acquired first information, and a display may be rendered on the display according to corresponding orientations and positions.

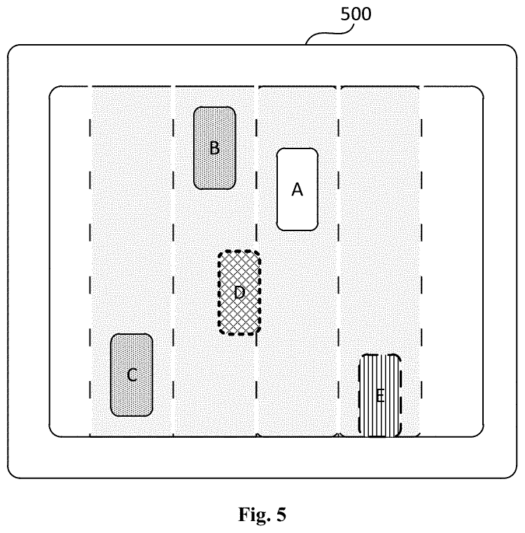

FIG. 5 depicts an example of a graphic interface 500 displaying travelling status of various vehicles according to the embodiments of the present disclosure. As shown in FIG. 5, the surrounding vehicles determined based on the acquired first information are respectively displayed on corresponding lanes. Each vehicle may be represented by a preset icon such as a simulated shape of the vehicle, or may be simply represented by characters such as A, B, C, as long as the vehicles may be distinguished and represented. The icon of each vehicle may act as an identifier of the vehicle.

After acquiring the first information of the surrounding vehicles, the vehicle monitoring apparatus may determine whether a surrounding vehicle is posing a risk. If there is a risk-posing vehicle, the risk-posing vehicle is displayed in the display mode different from that of other vehicles. For example, the risk-posing vehicles and the vehicles posing no risks may be displayed in different colors or patterns (especially in the case of a monochrome display).

As shown in FIG. 5, a target vehicle A and vehicles B and C surrounding the target vehicle that are running safely may be displayed in a first pattern, such as a pure color pattern. For example, the target vehicle A may be displayed in white, and the surrounding vehicles B and C may be displayed in gray. Risk-posing vehicles D and E may be displayed in a second pattern different from the first pattern. For example, the risk-posing vehicle D is displayed in a fine grid pattern, and the risk-posing vehicle E is displayed in a vertical stripe pattern. Additionally, different display modes (such as colors or patterns) for the risk-posing vehicles may indicate different factors that pose risks.

For example, when it is determined that the first information of the surrounding vehicles includes the speed information of a vehicle, it is possible to determine whether the vehicle is at an overspeed based on the speed limit of the road segment. The vehicle in overspeed status is an overspeed vehicle, and the identifier of the overspeed vehicle is displayed in a first color (for example, red).

Further, when it is determined that the first information of surrounding vehicles includes the violation record information of a vehicle, the identifier of the vehicle with the violation record is displayed in a second color (for example, orange). At the same time, a third color (such as green) may be used for displaying other normal vehicles or vehicles running safely.

By using the display modes with different colors, it is convenient for the driver to distinguish a risk-posing vehicle among the surrounding vehicles, such as the overspeed vehicle or the vehicle with violation record. This will alert the driver to the risk-posing vehicles, thus ensuring driving safety.

Additionally or alternatively, the risk-posing vehicles may also be highlighted by displaying the identifiers of the risk-posing vehicles in a flickering manner.

In the embodiments of the present disclosure, the above two display modes may be used in combination. Thus, on one hand, the risk-posing vehicles may be distinguished by colors, on the other hand, the risk-posing vehicles may be further highlighted by flickering, which makes it easier for the driver to acquire risk information.

Additionally, when it is determined that there is a risk-posing vehicle, prompt information may also be given by voice output. For example, the prompt information may include orientation and position information and/or risk factor of the risk-posing vehicle. For example, the prompt information may be broadcast by voice, such as “a left rear vehicle is overspeeding”. This allows the driver to acquire a warning of danger without looking away from the road ahead.

In some embodiments, after the second information about the drivers is acquired from the data management server, the driver information of each surrounding vehicle may also be displayed correspondingly. The driver information may include information such as age, gender, health status, or driving experience.

The driver information may be displayed by means of a label linked to the corresponding vehicle, or may be displayed when touch selection information with respect to the corresponding vehicle is received.

Further, it may be determined whether the second information of the driver poses risks. For example, it may be determined whether the driver's age is greater than a preset age (e.g., an age over 60 years old), whether the driver's driving experience is less than a preset driving experience (no more than three years), or whether the driver has disorders that may handicap driving, such as disorders involving eye, brain or limb. When any one of the above determination gives a positive result, it is determined that the driver poses a risk.

Then the vehicle associated with the risk-posing driver may be displayed in a display mode different from that of other vehicles. As described above, the related vehicle may be displayed in a flickering manner or in a different color or the like.

Additionally, in the embodiments of the present disclosure, when it is determined that a vehicle is overspeeding, the overspeed vehicle may be further categorized into an overspeed level based on the speed information of the vehicle.

In some embodiments, the vehicle monitoring apparatus may request the speed limit, required for safe driving, of each lane in the current position from the data management server based on for example vehicle positioning information, or the data management server may also incorporate the corresponding speed limit required for safe driving in the returned information when generating the returned information.

The vehicle management apparatus may determine an overspeed level based on a difference between the speed of each surrounding vehicle and the speed limit required for safe driving. For example, when the speed difference is within a first preset range, the overspeed level is determined to be a first level, and when the speed difference is within a second preset range, the overspeed level is determined to be a second level. A speed value of the second preset range is larger than that of the first preset range. For example, the first preset range may be 0 km/h-20 km/h, while the second preset range may be larger than 20 km/h.

The identifiers of overspeed vehicles of different overspeed levels may be displayed in different modes. For example, the higher the overspeed level is, the more risk the overspeed vehicle poses, and thus the larger a flickering frequency of the displayed identifier of the corresponding vehicle is. For example, the identifier of the overspeed vehicle of the first level may flicker at a first frequency, and the identifier of the overspeed vehicle of the second level may flicker at a second frequency.

Optionally, the display of a vehicle may be further adjusted according to a quantity of the violation records included in the first information of the corresponding vehicle. For example, the larger the quantity of the violation records is, the faster the identifier of the vehicle flickers.

By using solutions according to the embodiments of the present disclosure, travelling status of the surrounding vehicles may be monitored in real time, and the surrounding vehicles may be represented by different display status, which makes it easy to alert the driver to the travelling status of the surrounding vehicles.

The method and process according to the embodiments of the present disclosure may be implemented in combination with any suitable hardware, software, firmware, or combination thereof. In at least some embodiments, the method may be performed by software in form of computer readable instructions stored on some type of computer readable storage medium, where the software may be executed on one or more processors.

The embodiments of the present disclosure further provide a vehicle monitoring apparatus, which may employ the vehicle monitoring method described in the above embodiments. Therefore, it is convenient to alert a driver to the status of surrounding vehicles, especially when there is a danger, the driver may also be assisted to perform corresponding operation quickly, thereby reducing a risk of driving and providing a safer driving environment.

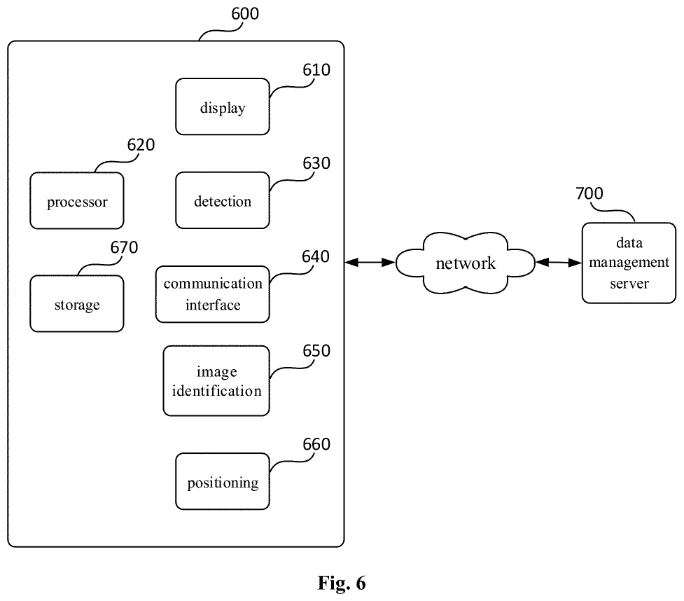

FIG. 6 is a schematic structural diagram of an exemplary vehicle monitoring apparatus 600 according to the embodiments of the present disclosure. The vehicle monitoring apparatus may include a display 610 and a processor 620 coupled to the display.

The display 610 may be configured to display vehicle information. The display may be a light emitting diode (LED) display or a liquid crystal display (LCD).

The processor 620 may acquire first information of one or more surrounding vehicles within a preset distance from a first vehicle, and optionally, may further acquire second information of drivers of the surrounding vehicles. The processor 620 may determine respective display modes of surrounding vehicles based on the first information and, in some cases, additionally based on the second information.

The display 610 is configured to display the corresponding vehicles according to the display modes determined by the processor 620.

In some embodiments, the vehicle monitoring apparatus according to the embodiments of the present disclosure may further include a detection device 630 configured to provide the first information of the surrounding vehicles and/or the second information related to the drivers of the surrounding vehicles. The processor 620 may be configured to acquire the first information and/or the second information from the detection device 630.

In some other embodiments, the vehicle monitoring apparatus may further include a communication interface 640 configured to communicate with other devices in the first vehicle or communicate with a remote data management server 700. The communication interface may be connected to other devices in the first vehicle by wireline or wirelessly. The communication interface may be connected to the remote data management server via a wireless network.

The processor 620 may be configured to acquire the first information of the surrounding vehicles and second information about the drivers of the surrounding vehicles from the detection device equipped in the first vehicle through the communication interface 640, or may request the first information of surrounding vehicles and the second information about drivers of surrounding vehicles from the remote data management server 700.

The first information about the vehicle may include: vehicle positioning information, driving lane information, running speed information, vehicle violation record information and vehicle age information. The second information about the driver may include information of the driver corresponding to the vehicle, etc. For example, the second information may include information such as driver's age, gender, driving experience, driving-related health conditions, and violation record information.

In one example, the detection device 630 may include a speed detector, such as a radar speedometer. The speed detector may detect the speed of a target vehicle, and relative speeds of other surrounding vehicles relative to the target vehicle which are within the preset distance from the target vehicle. At the same time, based on the detected speed of the target vehicle and relative speeds of the surrounding vehicles relative to the target vehicle, running speeds of the surrounding vehicles may be calculated correspondingly. The first information of a surrounding vehicle may be generated based on the running speed of the corresponding vehicle.

The preset distance may be set autonomously according to a detection accuracy or configuration requirements of the detection device.

In some embodiments, the processor 620 may determine whether the surrounding vehicle is overspeeding after acquiring the running speed of the surrounding vehicle, and if the surrounding vehicle is overspeeding, it is determined the overspeed vehicle is to be displayed in a different display mode from that of other vehicles.

In some embodiments, the processor 620 may also request the first information of each surrounding vehicle and/or the second information about the driver of the surrounding vehicle from the data management server 700 via the communication interface 640.

The data management server 700 may include a self-configured server, or include a server of the public security traffic supervision system. In some embodiments, the data management server 700 may acquire running speed information, positioning information, vehicle violation status information, and driver information of all vehicles within the jurisdiction of the public security traffic supervision system.

The processor 620 may generate a data request for the first information of the surrounding vehicles when the vehicle monitoring apparatus is activated, and send the data request to the data management server via the communication interface. In some embodiments, the data request may include identification information of the target vehicle or identification information of the surrounding vehicles. The identification information may include positioning information or license plate information of the vehicles.

The vehicle monitoring apparatus may further include a device 660 configured to acquire the positioning information. For example, the vehicle monitoring apparatus may include a GPS locator to acquire the positioning information of the target vehicle. The processor may incorporate the positioning information in the data request as the identification information of the target vehicle.

Additionally, the vehicle monitoring apparatus may also include an image identification device 650 that may capture and identify images of the surrounding vehicles. Alternatively, the image identification device 650 may also identify the images of the surrounding vehicles captured by an image capture device equipped on the target vehicle. The images of the surrounding vehicles may include images of the license plates. The image identification device may be configured to analyze the captured picture, to identify the license plate information in the picture as the identification information of the surrounding vehicles.

The vehicle monitoring apparatus may further include a storage 670 configured to store the license plate information of the target vehicle as the identification information of the target vehicle.

Having received the data request generated by the processor 620, the data management server 700 may acquire the identification information about the target vehicle and/or the surrounding vehicles from the data request, and acquire (e.g., search) the first information of the surrounding vehicles based on the identification information, such as the positioning information, the running speed, vehicle age information or the violation record information. In response to the data request from the processor 620, the data management server 700 generates the returned information by using the acquired first information of the surrounding vehicles and sends the returned information.

In one example, when the identification information is the positioning information of the target vehicle, the data management server 700 may acquire a position of the target vehicle from the data request. In another example, when the identification information is the license plate information of the target vehicle, the data management server 700 may acquire the license plate number of the target vehicle from the data request, and determine the position of the target vehicle from a relevant database based on the license plate number. Based on the position of the target vehicle, the data management server 700 may search the first information, such as the speed information, vehicle violation information, etc., of surrounding vehicles in the vicinity of the position (e.g., within a preset distance from the position), and incorporate the searched first information in the returned information.

In addition, when the identification information is the license plate information of the surrounding vehicles, the data management server 700 may acquire the license plate numbers of the surrounding vehicles from the data request upon the data request is received. The data management server 700 may search the first information of the corresponding vehicle, for example, current positioning information, violation information, or speed information of the vehicle, in for example a relevant database according to the license plate number, and incorporate the searched first information in the returned information.

It should be appreciated that, multiple databases may be used for storing vehicle related data. For example, one of the databases may be a real-time vehicle information database, which may store running information uploaded by each vehicle in real time, such as vehicle speed information, positioning information, and vehicle travelling routes. Another one of the databases may be a vehicle history information database that may store basic information of the vehicles (such as license plate numbers, vehicle ages, and vehicle owners) or the violation information and the like. Still another one of the databases may be a driver database that may store the driver's basic information (names, genders, dates of birth, photos) and/or driver's violation records, and the like. These databases may be maintained by the data management server or the public security traffic supervision system. The data management server may access or may be authorized to access these databases to obtain relevant information.

The data in the database may be updated in real time. In one example, the data management server may periodically request the public security traffic supervision system to update relevant data. In another example, the data management server may also request a health care management system to update health data (diagnosis and treatment information, medical history, etc.) of each driver. This ensures that the first information and the second information acquired by the data management server are updated in real time and accurate.

According to the embodiments of the present disclosure, real-time acquisition of the vehicle information and the driver information, and timely display may be achieved.

In the embodiments of the present disclosure, the processor 620 may be further configured to upload the speed information, the positioning information, and the like of the target vehicle to the data management server in real time through the communication interface 640.

After receiving the information returned by the data management server 700, the processor 620 may acquire the first information of each surrounding vehicle from the returned information. Then the display modes of the vehicles may be adaptively adjusted according to the first information.

In addition, in the embodiments of the present disclosure, the image identification device 650 may further identify captured images of the drivers of the surrounding vehicles. The identified driver information is used for requesting the second information of the drivers corresponding to the surrounding vehicles from the data management server. The second information includes at least one of: driver's age, driving experience, driving related health information, and violation records.

The image identification device 650 may include a camera and a face identifying unit coupled to the camera. The processor 620 may control the camera to take a picture of the driver of surrounding vehicle, and analyze headshot information in the picture by using the face identifying unit, thereby acquiring the driver's basic information such as age and gender.

In another aspect, the processor 620 may further request from the data management server the second information of the drivers of the surrounding vehicles. For example, the processor 620 may generate a data request for the second information of the driver. The data request may include a picture of the driver shot by the camera or the headshot information analyzed by the face identifying unit. The data management server may retrieve and return the second information of the drivers of the surrounding vehicles based on driver-related identification information included in the data request.

In some embodiments, the processor 620 may determine whether there is a risk-posing vehicle in the surrounding vehicles based on the acquired first information of the surrounding vehicles; and display the risk-posing vehicle in a display mode different from that of other vehicles when it is determined there is the risk-posing vehicle in the surrounding vehicles. In some embodiments, the second information of the driver of the corresponding vehicle is also displayed in association with the vehicle.

For example, the processor 620 may be configured to determine whether a vehicle poses a risk according to certain rules. In one embodiment, one or more predefined rules may be stored in the storage 670. For example, the rules may be based on the vehicle speed. For example, when the first information includes the speed information of the vehicle and the speed information indicates that a current vehicle speed of the vehicle exceeds a speed limit of a current road, it may be determined that the vehicle is overspeeding. Then the processor 620 may determine to display the vehicle in a display mode different from that of other vehicles, such as an iconic or text identifier of the vehicle.

For example, the rules may be based on the vehicle violation records. For example, when the first information includes the vehicle violation record information, the processor 620 may determine to display the vehicle with the violation record in a display mode different from that of other vehicles.

In some embodiments, the processor 620 may further determine whether there is a risk-posing vehicle. Further, the processor 620 may determine whether there is a risk-posing vehicle based on the acquired second information of the drivers of the surrounding vehicles. For example, the rules may be based on the driver's violation record, age or health condition. For example, the rule may include whether the driver has a violation record, whether the driver's age is greater than a preset age (e.g., an age over 60 years old), whether the driver's driving experience is less than a preset driving experience (no more than three years), or whether the driver has disorders involving eye, brain or limb, and the like. For example, when the second information includes the driver's violation record information, the processor 620 may determine that the driver and corresponding vehicle pose a risk. Then the processor 620 may determine to display the vehicle related to the risk-posing driver in a display mode different from that of other vehicles. The different display modes include, for example, displaying the risk-posing vehicle and the vehicles posing no risks in different colors.

In one example, the processor 620 may determine to display, in different colors, the vehicles determined to be risk-posing according to different rules. For example, the processor 620 may determine to display overspeed vehicles in a first color, display vehicles with violation records in a second color, and display other normal vehicles or vehicles running safely in a third color.

By using the display modes with different colors, it is convenient for the driver to distinguish vehicles posing a risk among the surrounding vehicles. This may alert the driver to the risk-posing vehicles, thus ensuring safe driving.

Further, apart from displaying the identifiers of various vehicles in different display colors, the processor 620 may determine to display the risk-posing vehicle in a flickering manner.

In the embodiments of the present disclosure, the processor 620 may also determine to display the risk-posing vehicle with the aforementioned two display modes combined. For example, on one hand, the risk-posing vehicle may be distinguished by means of color, and on the other hand, the risk-posing vehicle may be further highlighted by means of flickering.

In some embodiments, the vehicle monitoring apparatus may further include a speaker configured to output vocal alert information when it is determined that there is a risk-posing vehicle.

In addition, in some scenarios, particularly in the scenario where the risk-posing vehicle is determined based on the second information about the driver, the driver information may be displayed by means of a label of the relevant vehicle, or may be displayed when a corresponding user selection input is received.

For example, when a display device is a touch screen, initially, the driver information may not be displayed. The processor 620 may be configured to instruct the display device to display the driver information corresponding to the vehicle when a user's touch input selecting the relevant vehicle is received via the touch screen.

Additionally, in the embodiments of the present disclosure, when it is determined that a vehicle is overspeeding, the processor 620 may further categorize the overspeed vehicle into an overspeed level. In some embodiments, the processor 620 may request from the data management server 700 the speed limit required for safe driving of the current road and/or lane, and categorize the overspeed vehicles into different overspeed levels based on speed differences between the overspeed vehicles and the speed limit. The processor 620 may determine to display the overspeed vehicles of different overspeed levels in different display modes. For example, the higher the overspeed level is, the larger a flickering frequency of the displayed identifier of the corresponding vehicle is.

Or, the processor 620 may adjust the display of the surrounding vehicle according to a quantity of the violation records included in the first information of the corresponding vehicle. For example, the larger the quantity of the violation records is, the faster the identifier of the vehicle may flicker.

The vehicle monitoring apparatus according to the embodiment of the present disclosure may exist in form of independent equipment, or may be integrated with a vehicle control system.

In some embodiments, the vehicle monitoring apparatus may be implemented in form of a computing device configured with an application (such as an app) implementing a corresponding vehicle monitoring function. The computing device may include, but is not limited to, a smartphone, a tablet, a personal digital assistant, etc.

In some embodiments, a computer program or a computer program unit is provided, which is suitable for performing steps of the method according to one of the foregoing embodiments on an appropriate system.

The computer program unit may be stored on the computing device which may also be a part of the embodiments of the present disclosure. The computing device may include a memory and a processing unit. The computer program unit may be loaded into the memory. The computing device is suitable for performing the steps of the method described above or facilitating the execution of the steps of the method described above when the processing unit executes the computer program unit. Moreover, the computer program unit may be suitable for operating the various components described above. The computing device may be suitable for automatically operating and/or executing user's commands.

According to a further embodiment of the present disclosure, a computer-readable medium, such as a CD-ROM, is proposed, on which the computer program unit described above is stored.

The computer program may be stored and/or distributed on a suitable medium, such as an optical storage medium or a solid-state medium provided together with or as part of other hardware. However, the computer program may also be distributed in other forms, such as via the Internet or other wired or wireless telecommunication systems.

By using the solutions according to the embodiments of the present disclosure, travelling status of surrounding vehicles may be monitored in real time, and vehicles posing safety risks may be highlighted by means of a different display mode, which makes it easy to alert the driver to potential safety risks posed by the surrounding vehicles.

It is appreciated that, although a detailed description is omitted, all options discussed with respect to the method according to the embodiments of the present disclosure are also valid for the apparatus according to the embodiments of the present disclosure.

Ordinal numbers such as “first” and “second” are used for modifying corresponding units in the present disclosure, which does not imply any priority, preference or precedence of one unit over another unit, or a time order for performing actions of the method, rather, is merely used as a label to distinguish a claim element with a certain name from another element with the same name.

The above are merely exemplary embodiments of the present disclosure, and the present disclosure is not limited thereto. The scope of the present disclosure is defined by the claims. It should be appreciated that a person skilled in the art may make further modifications or substitutions without departing from the substance and scope of the present disclosure, and these modifications or substitutions shall also fall within the scope of the present disclosure.

1. A vehicle monitoring method, comprising:
acquiring first information of one or more second vehicles within a preset distance from a first vehicle;
determining, based on the first information, respective display modes for the one or more second vehicles; and
displaying, according to the determined respective display modes, the one or more second vehicles on a display device of the first vehicle.

2. The vehicle monitoring method according to claim 1, wherein the first information comprises at least one of vehicle speed information, vehicle age information and vehicle violation record information, and the acquiring the first information of the one or more second vehicles within the preset distance from the first vehicle comprises:
detecting the vehicle speed information of the one or more second vehicles by using a speed detector in the first vehicle and/or requesting information of the one or more second vehicles from a data management server, and generating the first information based on the detected vehicle speed information of the one or more second vehicles and/or the information of the one or more second vehicles returned by the data management server.

3. The vehicle monitoring method according to claim 1, further comprising:
acquiring second information of one or more drivers of the one or more second vehicles,
wherein the determining the respective display modes for the one or more second vehicles further comprises:
determining, based on the first information and the second information, the respective display modes for the one or more second vehicles.

4. The vehicle monitoring method according to claim 3, wherein the acquiring the first information and the second information of the one or more second vehicles further comprises:
sending a data request for the first information and/or second information to a data management server;
receiving information returned by the data management server in response to the data request; and
parsing the returned information to acquire the first information and/or the second information of the one or more second vehicles.

5. The vehicle monitoring method according to claim 4, wherein the data request comprises identification information of the first vehicle or the one or more second vehicles.

6. The vehicle monitoring, method according to claim 3, wherein the determining the respective display modes for the one or more second vehicles comprises:
determining whether there is a risk-posing vehicle in the one or more second vehicles based on the acquired first information and/or second information of the one or more second vehicles; and
determining to display the risk-posing vehicle in a display mode different from that of other vehicles in case that it is determined there is the risk-posing vehicle in the one or more second vehicles.

7. The vehicle monitoring method according to claim 6, wherein the displaying the risk-posing vehicle in the display mode different from that of other vehicles comprises: displaying the risk-posing vehicle in a different color or in a flickering manner.

8. The vehicle monitoring method according to claim 6, wherein the determining whether there is the risk-posing vehicle in the one or more second vehicles is further based on different rules; and
the method further comprises:
displaying risk-posing vehicles, determined based on the different rules, in different display modes.

9. A vehicle monitoring apparatus, comprising:
a processor, configured to acquire first information of one or more second vehicles within a preset distance from a first vehicle; and determine, based on the first information, respective display modes for the one or more second vehicles; and
a display, configured to display the one or more second vehicles according to the respective display modes determined by the processor.

10. The vehicle monitoring apparatus according to claim 9, further comprising:
a speed detector, configured to detect vehicle speed information of the one or more second vehicles;
wherein the processor is configured to acquire the vehicle speed information of the one or more second vehicles from the speed detector as the first information.

11. The vehicle monitoring apparatus according to claim 9, wherein the processor is further configured to acquire second information of one or more drivers of the one or more second vehicles, and determine the respective display modes for the one or more second vehicles based on the first information and the second information.

12. The vehicle monitoring apparatus according to claim 11, further comprising a communication interface, configured to communicate with a data management server,
wherein the processor is configured to send a data request for the first information and/or the second information of the one or more second vehicles to the data management server via the communication interface, and generate the first information and/or the second information based on information returned by the data management server.

13. The vehicle monitoring apparatus according to claim 12, wherein the processor is configured to incorporate identification information of the first vehicle and/or the one or more second vehicles in the data request.

14. The vehicle monitoring apparatus according to claim 13, further comprising an image identification device, configured to identify license plate information or driver information of the one or more second vehicles as identification information of the one or more second vehicles by capturing an image of the one or more second vehicles and analyzing the captured image of the one or more second vehicles.

15. The vehicle monitoring apparatus according to claim 11, wherein the processor is configured to determine whether there is a risk-posing vehicle in the one or more second vehicles based on at least one of the acquired first information and second information of the one or more second vehicles, and display the risk-posing vehicle in a display mode different from that of other vehicles in case that it is determined there is the risk-posing vehicle in the one or more second vehicles.
